(19) United States
(12) Patent Application Publication
(10) Pub. No.: US 2026/0121954 A1
(43) Pub. Date: Apr. 30, 2026

(54) ENERGY REPORTING AND NOTIFICATION WITH MULTI-ACCESS MEDIA DELIVERY

(71) Applicant: Samsung Electronics Co., Ltd., Suwon-si (KR)

(72) Inventor: Prakash Reddy Kolan, Plano, TX (US)

(21) Appl. No.: 19/358,359

(22) Filed: Oct. 14, 2025

Related U.S. Application Data
(60) Provisional application No. 63/713,390, filed on Oct. 29, 2024.
(60) Provisional application No. 63/718,262, filed on Nov. 8, 2024.

(51) Int. Cl. H04L 43/065; H04L 43/026; H04L 43/08

(52) U.S. Cl. CPC H04L 43/065; H04L 43/026; H04L 43/08

(57) ABSTRACT

Methods, apparatuses, and computer readable media for energy reporting and notification with multi-access media delivery. A method for monitoring energy consumption includes receiving, from a user equipment (UE), first energy consumption information associated with an application session for a service in a multi-access network, receiving, from a plurality of network entities in a plurality of access paths between the UE and the multi-access network, second energy consumption information, and determining, based on the first and second energy consumption information, a total energy consumption value for access paths from a list of access paths. The first and second energy consumption information includes a service identifier corresponding to the service, a start time, an end time, and an access energy consumption map indicating the list of access paths, including access end points or network functions used to access the service between the start and end times and measured energy consumption attributed.

### CROSS-REFERENCE TO RELATED APPLICATIONS AND CLAIM OF PRIORITY

This application claims priority under 35 U.S.C. § 119(e) to U.S. Provisional Patent Application No. 63/713,390 filed on Oct. 29, 2024, and U.S. Provisional Patent Application No. 63/718,262 filed on Nov. 8, 2024. The above-identified provisional patent applications are hereby incorporated by reference in their entirety.

### TECHNICAL FIELD

This disclosure relates generally to wireless networks. More specifically, this disclosure relates to energy reporting and notification with multi-access media delivery.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for energy reporting and notification with multi-access media delivery.

In one embodiment, a method for monitoring energy consumption is provided. The method includes receiving, from a user equipment (UE), first energy consumption information associated with an application session for a service in a multi-access network and receiving, from a plurality of network entities in a plurality of access paths between the UE and the multi-access network, second energy consumption information. The first and second energy consumption information includes a service identifier corresponding to the service, a start time indicating a time at which measurement of energy consumption began, an end time indicating a time at which measurement of energy consumption ended, and an access energy consumption map indicating a list of access paths, including access end points or network functions in each access path from the list of access paths, used to access the service between the start and end times and measured energy consumption attributed to the access end points or the network functions corresponding to the access paths from the list of access paths. The method further includes determining, based on the first and second energy consumption information, a total energy consumption value for each of the access paths from the list of access paths.

In another embodiment, an apparatus for monitoring energy consumption is provided. The apparatus includes a communication interface configured to receive, from a UE, first energy consumption information associated with an application session for a service in a multi-access network and receive, from a plurality of network entities in a plurality of access paths between the UE and the multi-access network, second energy consumption information. The first and second energy consumption information includes a service identifier corresponding to the service, a start time indicating a time at which measurement of energy consumption began, an end time indicating a time at which measurement of energy consumption ended, and an access energy consumption map indicating a list of access paths, including access end points or network functions in each access path from the list of access paths, used to access the service between the start and end times and measured energy consumption attributed to the access end points or the network functions corresponding to the access paths from the list of access paths. The apparatus further includes a processor operably coupled with the communication interface. The processor is configured to determine, based on the first and second energy consumption information, a total energy consumption value for each of the access paths from the list of access paths.

In yet another embodiment, a non-transitory, computer readable medium is provided. The computer readable medium comprises program code that, when executed by a processor of an apparatus, causes the apparatus to receive, from a UE, first energy consumption information associated with an application session for a service in a multi-access network, receive, from a plurality of network entities in a plurality of access paths between the UE and the multi-access network, second energy consumption information, and determine, based on the first and second energy consumption information, a total energy consumption value for each of the access paths from the list of access paths. The first and second energy consumption information includes a service identifier corresponding to the service, a start time indicating a time at which measurement of energy consumption began, an end time indicating a time at which measurement of energy consumption ended, and an access energy consumption map indicating a list of access paths, including access end points or network functions in each access path from the list of access paths, used to access the service between the start and end times and measured energy consumption attributed to the access end points or the network functions corresponding to the access paths from the list of access paths.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates examples of intra-PLMN and inter-PLMN scenarios for using multiple access networks according to embodiments of the present disclosure;

FIG. 5 illustrates an example dual steering architecture according to embodiments of the present disclosure;

FIG. 6 illustrates an example steering functionalities architecture according to embodiments of the present disclosure;

FIG. 7 illustrates an example 5G media streaming session with multi-access media delivery according to embodiments of the present disclosure;

FIG. 8 illustrates another example 5G media streaming session with multi-access media delivery according to embodiments of the present disclosure;

FIG. 9 illustrates an example dynamic policy procedure for a 5G media streaming session with multi-access media delivery according to embodiments of the present disclosure;

FIG. 10 illustrates an example 5GMS architecture according to embodiments of the present disclosure;

FIG. 11 illustrates an example architecture for reporting energy consumption information according to embodiments of the present disclosure;

FIGS. 12A and 12B illustrate example architectures for energy notification to a UE according to embodiments of the present disclosure;

FIG. 13 illustrates an example architecture for energy notification to a UE for requested actions according to embodiments of the present disclosure;

FIGS. 14A and 14B illustrate example architectures for providing recommended actions by an application service provider according to embodiments of the present disclosure;

FIG. 15 illustrates an example architecture for energy policy configuration by an application service provider (ASP) according to embodiments of the present disclosure;

FIG. 16 illustrates an example architecture for energy management of RAN nodes with multi-access media delivery according to embodiments of the present disclosure

FIG. 17 illustrates an example architecture for a DNS based procedure for application server lookup according to embodiments of the present disclosure; and

FIG. 18 illustrates an example method for a method for monitoring energy consumption according to embodiments of the present disclosure.

### DETAILED DESCRIPTION

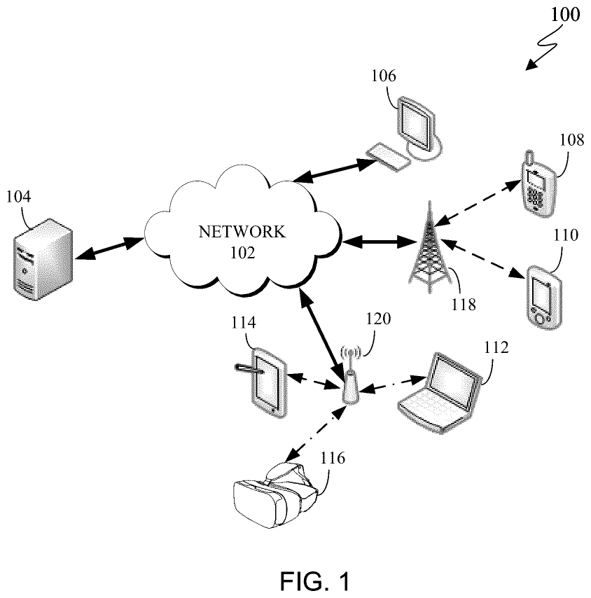

FIGS. 1 through 18, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

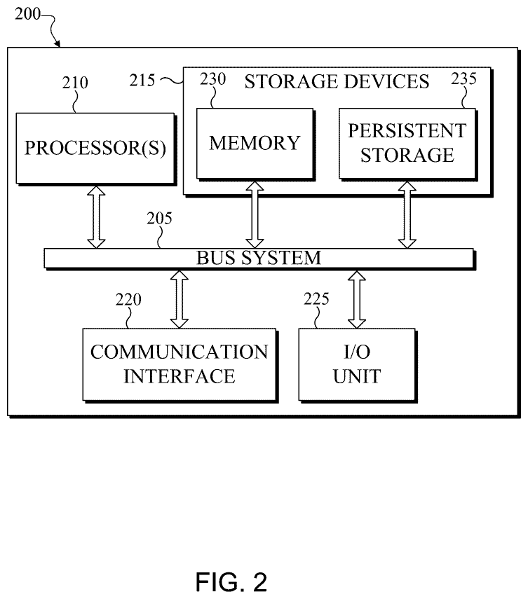

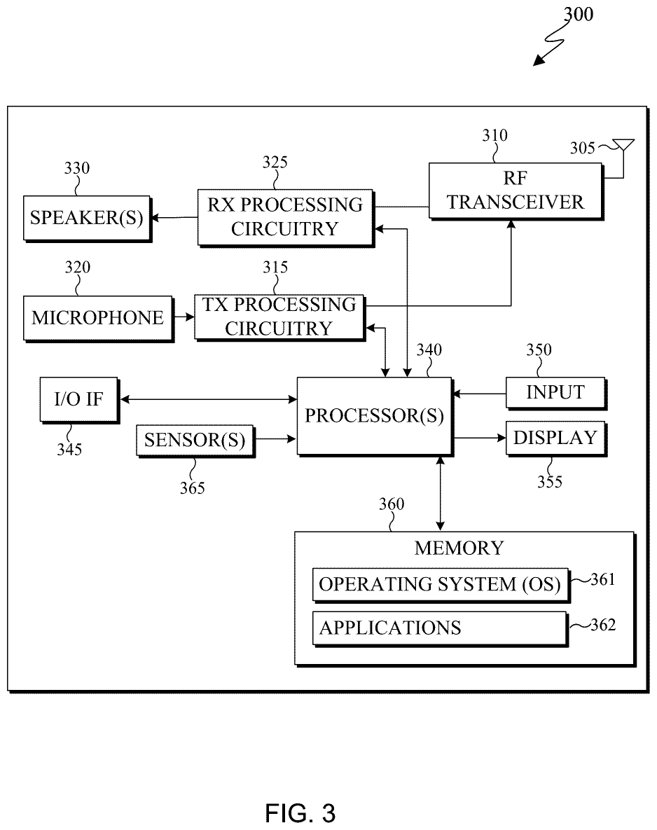

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 may a network entity or perform functions on behalf or entities in the network 102. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Various embodiments of the present disclosure recognize that for widespread adoption of multi-access delivery capabilities at the UE for an application level service, many aspects have to be carefully considered. One of the aspects that multi-access delivery procedures being developed today fail to consider is energy conservation. It is likely that an increase in throughput and bandwidth with multi-access delivery bring with it the challenge of higher energy costs at both the UE and the network. At the UE side, the device has to enable transmitting and receiving data over multiple access endpoints that take up UE energy cycles, and at the network side, additional network functions have to be provisioned by the network operator to process data from the UE over different access networks. In addition to this, processing has to be enabled to multiplex and de-multiplex data at both the UE and the network, so that application level endpoints do not see multiple access networks being used for delivering the service data.

Accordingly, various embodiments of the present disclosure describe aspects related to switching between single and multi-access sessions for media delivery services, and energy consumption and notification procedures to help with energy conservation during multi-access media delivery, including application configuration of multiple paths during multi-access media delivery and switching between single and multi-access sessions because of energy considerations, and energy consumption reporting and feedback notification to manage multi-access media delivery. Aspects include methods and apparatuses for reporting and computing energy consumption for multi-access paths delivering a media service, and methods and apparatuses for energy consumption notification and recommended actions for energy conservation in multi-access media delivery.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

The present disclosure describes aspects related to using multiple access for transporting an application level service such as 5G media streaming. A description of some of the functions described in this disclosure are follows:
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.

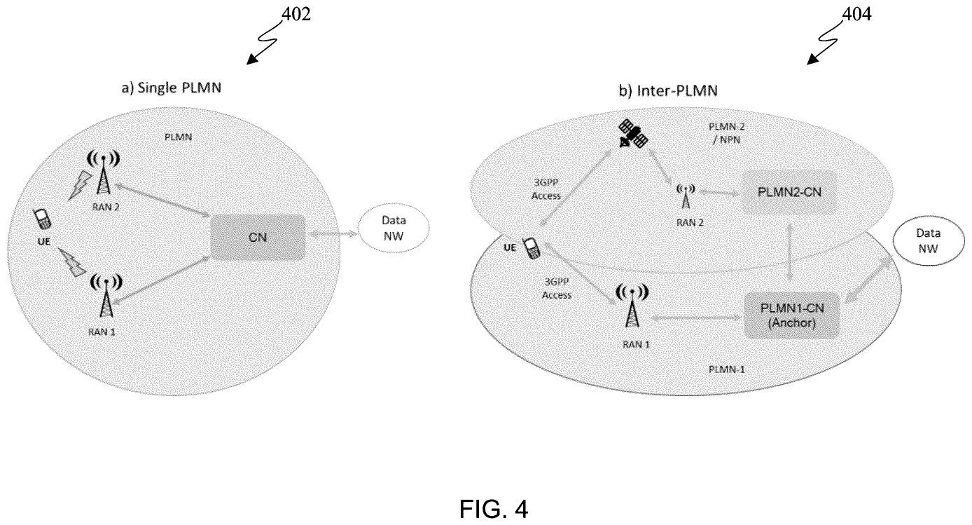

Wireless networks may support a set of use cases and service requirements related to 5G system support of traffic switching, splitting, and steering of a UE's user data across multiple 3GPP access networks. FIG. 4 shows examples of intra-public land mobile network (PLMN) and inter-PLMN scenarios for using multiple access networks.

FIG. 4 illustrates examples 402-404 of intra-PLMN and inter-PLMN scenarios for using multiple access networks according to embodiments of the present disclosure. The embodiments of intra-PLMN and inter-PLMN scenarios of FIG. 4 are for illustration only. Different embodiments of intra-PLMN and inter-PLMN scenarios for using multiple 3GPP access networks.

In the examples of FIG. 4 the UE is connected to more than one access network at the same time. Traffic from different applications installed on the UE may use one or more access networks to connect to the UE's service endpoints, either inside the operator network, or through the operator network into the external Internet. The type of access networks are not limited to terrestrial mobile networks, but could also be satellite networks, non-public networks (NPNs) etc. In example 402, the UE is connected to multiple access networks of the same PLMN, while in example 404, the UE is connected to access networks of different PLMNs.

Although FIG. 4 illustrates examples 402-404 of intra-PLMN and inter-PLMN scenarios for using multiple 3GPP access networks, various changes may be made to FIG. 4. For example, examples 402-404 could include additional access networks, different access networks, etc. according to particular needs.

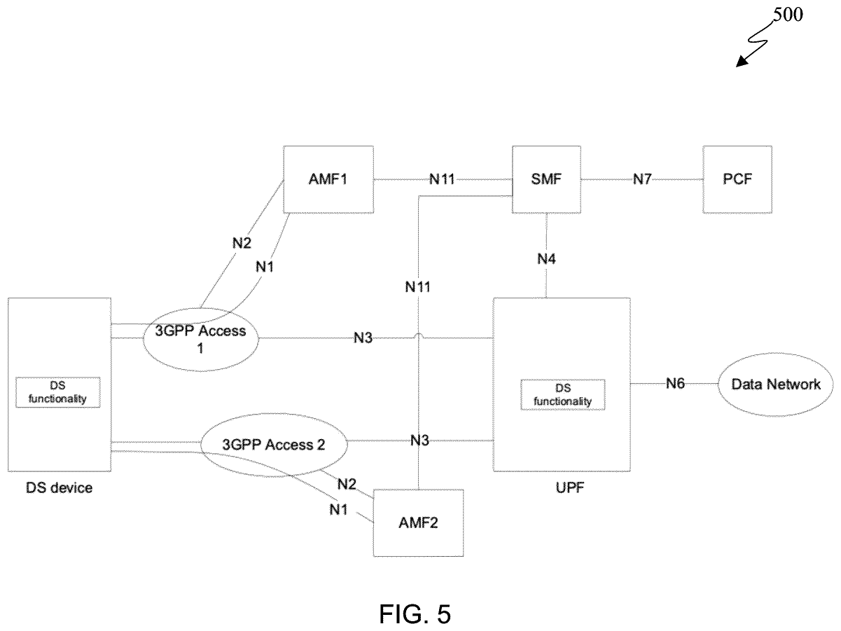

Wireless networks may support operation of a dual steering (DS) device that is capable of traffic steering and switching of user data for different services across two 3GPP access networks as shown in FIG. 5.

FIG. 5 illustrates an example dual steering architecture 500 according to embodiments of the present disclosure. The embodiment of a dual steering architecture of FIG. 5 is for illustration only. Different embodiments of a dual steering architecture could be used without departing from the scope of this disclosure.

In the example of FIG. 5, the dual steering functionality (DS functionality) inside the DS device allows connection to the operator network UPF using multiple 3GPP access networks. With the DS functionality, the network may see that the network is interacting with two different 3GPP UE endpoints when in fact it is the same UE that has credentials to access content over multiple access networks. The DS functionality enables separate registration and UE session management over each of the connected 3GPP access networks. With dual steer and multipath delivery as shown in FIG. 5, clients are able to use the capabilities of two or more access networks to connect to application service endpoints (or application servers) through the operator network.

Although FIG. 5 illustrates an example dual steering architecture 1000, various changes may be made to FIG. 5. For example, architecture 500 could include additional interfaces, routes, etc. according to particular needs.

In the present disclosure, architecture and procedures are described with one or more access networks. Sometimes, the one or more access networks are described as being 3GPP access and non-3GPP access. However, all the aspects in this disclosure equally apply to any of multiple types of access networks.

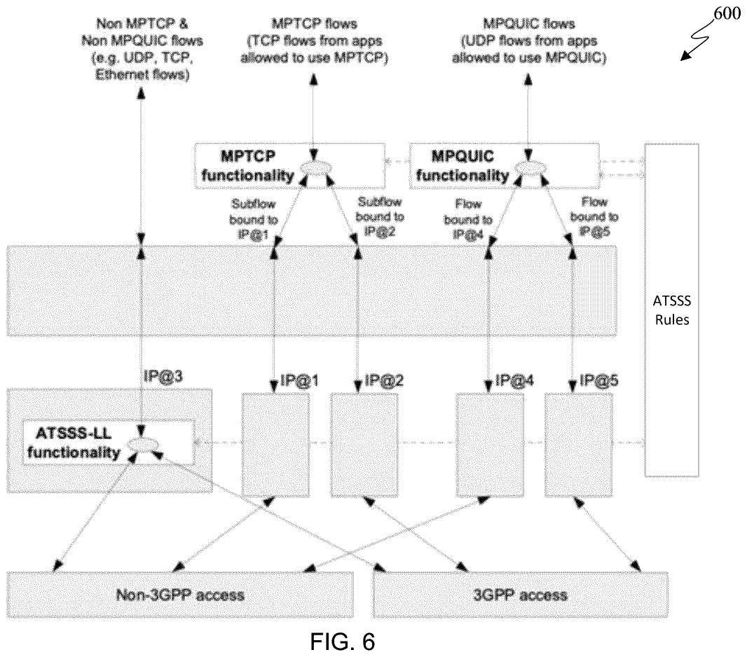

Wireless networks may support operation of access traffic steering, switching, and splitting (ATSSS) as shown in FIG. 6.

FIG. 6 illustrates an example steering functionalities architecture 600 according to embodiments of the present disclosure. The embodiment of a steering functionalities architecture of FIG. 6 is for illustration only. Different embodiments of a steering functionalities architecture could be used without departing from the scope of this disclosure.

In the example of FIG. 6, application control over data streams to be transmitted and received over multiple access endpoints on the UE are shown and discussed. Specifically, application considerations with MPTCP and MPQUIC are discussed.
Legacy Applications: These applications are unaware of MPTCP, and therefore use the existing TCP sockets API to interface with the MPTCP layer. This is the default case.
MPTCP-aware applications: These applications are aware of MPTCP functionality, and use an enhanced MPTCP API to interact with the MPTCP layer.

Following are some of the application interface capabilities with a basic API for an MPTCP-aware application while using MPTCP.
The application may be able to request to turn on or turn off the usage of MPTCP.
The application may restrict MPTCP to bind to a given set of IP addresses. The application possesses the capabilities to add a set of new local addresses to an existing MPTCP connection, or to remove a local address from an existing MPTCP connection.
The application may be able to obtain information on the pairs of addresses used by the MPTCP subflows.
The application may explicitly configure send and receive buffer sizes via the sockets API (SO_SNDBUF, SO_RCVBUF). These socket options can be used with MPTCP to affect the buffer sizes of the MPTCP connection.
The application may be able to retrieve the local connection identifier for the MPTCP connection.

Following are some of the potential requirements on an advanced API beyond the features of the basic API listed above available to the application to interface with the MPTCP layer.
The application may obtain usage information and statistics about all subflows (e.g., the ratio of traffic sent via this subflow).
The application may request a change in the number of subflows in use, thus triggering removal or addition of subflows. Requesting establishment of a specific subflow to a provided destination, or a request for termination of specific existing subflow may be possible.
The application may be able to inform the MPTCP implementation about its high-level performance requirements, e.g., in the form or a profile.
The application may be able to indicate the communication characteristics of the connection (e.g., expected amount and data rate to be sent over MPTCP connection, expected duration of connection etc.). Similar heuristics may be used by the application to manage (create new, or terminate existing) MPTCP subflows.
The application may be able to specify preferable subflows or subflow usage policies. This could change the behavior of MPTCP scheduler.
The application may be able to specify redundancy levels (e.g., specify whether TCP segments are to be sent on one path or more than one path in parallel).
The application may be able to register for callbacks to be informed when there are changes to subflows of the MPTCP connection.

Performance improvements for applications resulting from the use of MPTCP include throughput because the application is able to pool more than one path between two MPTCP endpoints. Another improvement is application resilience because if one path fails, the other paths are able to carry all the traffic, and if necessary any lost packets on a path may be retransmitted over one or more of the other available paths. However, two potential problems for applications using MPTCP, especially if they are applications with real-time requirements are as follows:
If the delays of different MPTCP subflows of an MPTCP connection differ, the jitter perceivable to an application may appear higher as the data is spread across multiple subflows. Although MPTCP ensures in-order delivery to the application, the data delivery could be more bursty than with a single-path TCP connection.
Some middleboxes may refuse to pass MPTCP data segments due to the presence of TCP options, or they may strip TCP options. In this case, MPTCP falls back to regular TCP operation. Although this is not a problem (because the corresponding application session is still ultimately usable for data exchange), there may be additional delays when the first handshake fails.

The following discuss a multipath extension for QUIC version 1 to enable simultaneous usage of multiple paths for a single QUIC connection, and the capabilities of an MPQUIC-aware application to interface with the MPQUIC implementation on the host/device.
The application using the QUIC multipath extension may use algorithms to define and handle the number of active paths and how they are used to send QUIC packets.
The application using the QUIC multipath extension may handle the IP addresses and the actual decision process to set up or tear down paths.
The application using the QUIC multipath extension may specify the maximum number of paths for a QUIC connection by setting the initial_max_path_id parameter or by sending a MAX_PATH_ID frame. The application may later revise the maximum number of paths for a QUIC connection.
The application using the QUIC multipath extension may define strategies to keep one or more paths alive by sending PING frames on those paths before the idle timeout expires.
D The application using the QUIC multipath extension may use the capabilities of the MPQUIC implementation to maintain separate congestion state for each path to avoid sending more data on a given path than congestion control for that path indicates.

An MPQUIC endpoint may use multiple IP addresses simultaneously for a connection. The multipath extension for QUIC supports the following scenarios:
The client uses multiple IP addresses, and the server listens on only one IP address.
The client uses only one IP address, and the server listens on multiple IP addresses.
The client uses multiple IP addresses, and the server listens on multiple IP addresses.
The client uses only one IP address, and the server listens on only one IP address.

Wireless networks may support a multi-access PDU session. A multi-access PDU session may be set up in one of three different ways:
1. The UE may set up a Single Access PDU Session over one access network and then register over another access network and request a Multi-access PDU Session to be set up using both the access networks.
2. The UE may indicate its capability for ATSSS and request the setting up of a Multi-access PDU Session to begin with.
3. The UE may request to set up a Single-Access PDU Session, but the network may transparently set up a Multi-access PDU Session instead.

For simplicity, for the high-level call flows for 5G Media Streaming with multi-access media delivery, the first option above is used.

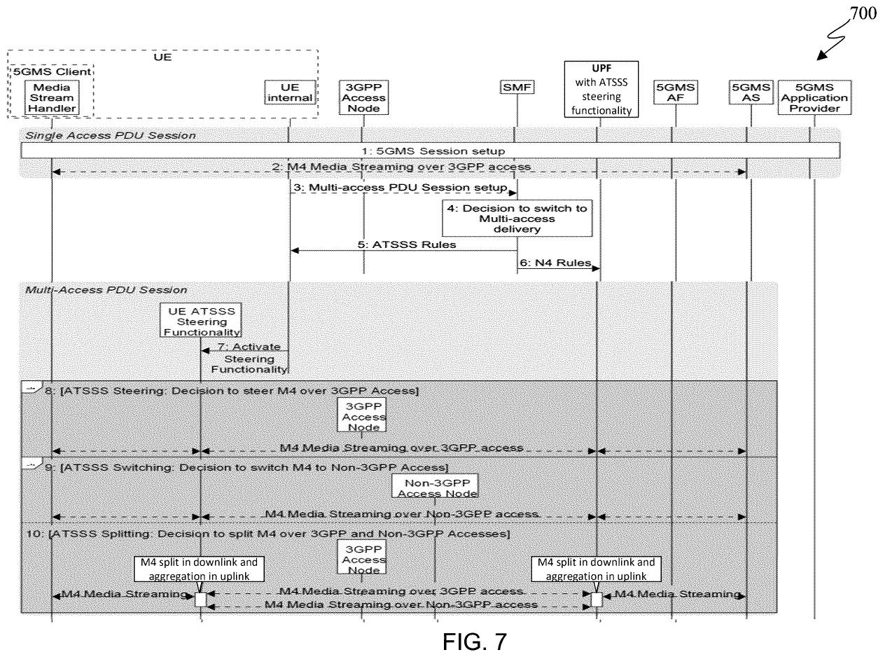

FIG. 7 illustrates an example 5G media streaming session with multi-access media delivery 700 according to embodiments of the present disclosure. The embodiment of a 5G media streaming session with multi-access media delivery of FIG. 7 is for illustration only. Different embodiments of a 5G media streaming session with multi-access media delivery could be used without departing from the scope of this disclosure.

In the example of FIG. 7, a high-level call flow for a 5G media streaming session over a multi-access PDU session that uses two different access networks: a 3GPP access and a non-3GPP access is shown. The following assumptions are made:
The 5GMS Client is unaware of the UE ATSSS steering functionality.
The 5G media streaming session is set up over 3GPP access first before the UE switches to a Multi-Access PDU Session to use both the access networks.

In the example of FIG. 7, the steps are as follows:
1. The UE sets up a single-access PDU Session over the 3GPP access using a PDU Session establishment procedure. The 5GMS entities on the UE set up a 5G media streaming session over the single-access PDU Session.
2. The media stream handler in the 5GMS client of the UE interacts with the 5GMS AS for M4 media streaming over 3GPP access.
3. The UE requests setting up a multi-access PDU session spanning both the 3GPP access network and the non-3GPP access network with the SMF. This request includes UE capabilities for ATSSS multi-access delivery and the UE's preferred steering functionalities.
4. A decision is made by the SMF to switch the single-access PDU session of the UE to a multi-access PDU session. (The SMF may interact with the PCF to make this decision.)
5. The SMF sends updated ATSSS rules to the UE.
6. The SMF updates the forwarding behaviour of the UPF for the multi-access PDU session by sending updated N4 rules for multi-access delivery to the UPF. Based on the the received N4 rules, the UPF activates the required steering functionality.
7. The UE-internal component processing the received ATSSS rules activates the UE ATSSS steering functionality in the UE.
8. If the highest priority rule in the received ATSSS rules indicates steering of traffic towards a specific access network (e.g., 3GPP access), then:
   In the uplink direction, the M4 media flows from the media stream handler are sent to the UE ATSSS steering functionality, which then forwards the media flows to the UPF over the 3GPP access network, and the UPF forwards the media flows to the 5GMS AS.
   In downlink direction, the M4 media flows from the 5GMS AS are sent to the UPF, which then forwards them to the UE ATSSS steering functionality over the 3GPP access network, which then forwards them to the media stream handler in 5GMS client.
9. If the high priority rule in the received ATSSS rules indicates switching of traffic towards a specific access network (e.g., from 3GPP access to non-3GPP access), then:
   In the uplink direction, the M4 media flows from the media stream handler are sent to the UE ATSSS steering functionality, which then forwards the media flows to the UPF over the non-3GPP access, and the UPF forwards the media flows to the 5GMS AS.
   In the downlink direction, the M4 media flows from the 5GMS AS are sent to the UPF, which then forwards the media flows to the UE ATSSS steering functionality over the non-3GPP access network, which then forwards them to the media stream handler in 5GMS Client.
10. If the highest priority rule in the received ATSSS rules indicates splitting of traffic between two access networks (e.g., 3GPP access and non-3GPP access), then:
In the uplink direction, the M4 media flows from the media stream handler are sent to the UE ATSSS Functionality. The UE ATSSS steering functionality then splits the M4 media flow traffic according to the criteria defined in the ATSSS rules and distributes it between both the 3GPP access and the non-3GPP access networks when forwarding it to the UPF. The split M4 flows arrive at the UPF where the ATSSS steering functionality in the UPF aggregates the split M4 traffic, and then forwards the aggregated M4 flows to the 5GMS AS.
In the downlink direction, the M4 media flows from the 5GMS AS are sent to the ATSSS steering functionality in the UPF. The ATSSS steering functionality in the UPF then splits the M4 media flow traffic according to the criteria defined in the N4 rules and distributes it between both the 3GPP access and non-3GPP access networks when forwarding it to the UE. The split M4 flows arrive at the UE. The UE ATSSS steering functionality aggregates the split M4 traffic, and then forwards the aggregated M4 flows to the media stream handler in the 5GMS client of the UE.

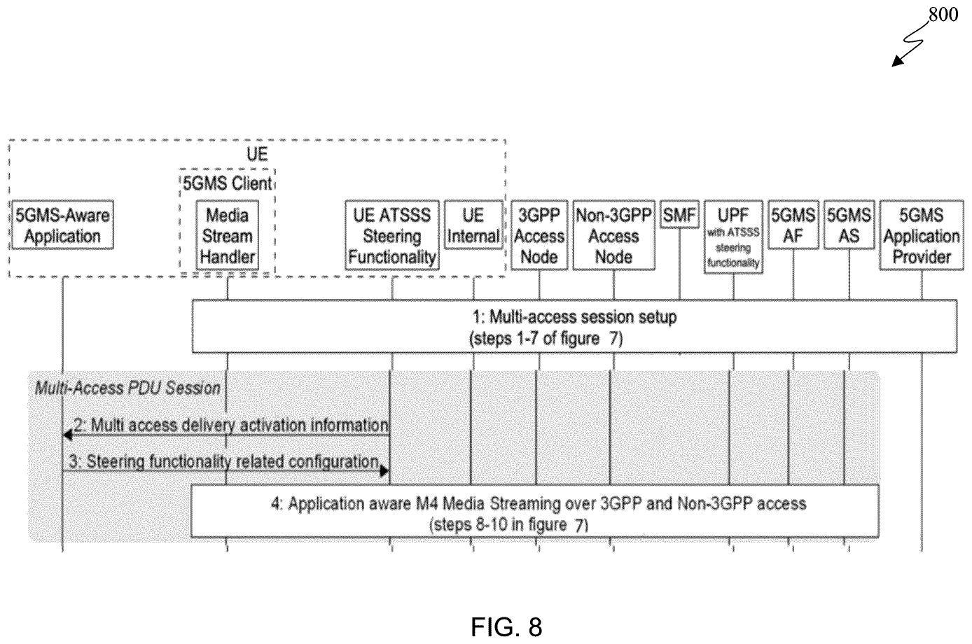

FIG. 8 illustrates another example 5G media streaming session with multi-access media delivery 800 according to embodiments of the present disclosure. The embodiment of a 5G media streaming session with multi-access media delivery of FIG. 8 is for illustration only. Different embodiments of a 5G media streaming session with multi-access media delivery could be used without departing from the scope of this disclosure.

In the example of FIG. 8, a high-level call flow for a 5G media streaming session over a multi-access PDU session that uses two different access networks: a 3GPP access and a non-3GPP access, when the 5GMS-aware application is aware of ATSSS functionality in the UE is shown.

The steps are as follows:
1. A 5G media streaming session over a multi-access PDU session is set up as described herein. This includes setting up ATSSS functionality in the UE for multi-access media delivery.
2. The 5GMS-aware application receives information from the UE ATSSS steering functionality that multi-access delivery is being activated. The UE ATSSS steering functionality may provide information to the 5GMS-aware application about the multipath connection and associated subflows/paths.
3. The 5GMS-aware application configures the UE ATSSS steering functionality as described herein.
4. The media stream handler in the 5GMS client interacts with the 5GMS AS using multiple access networks as described herein.

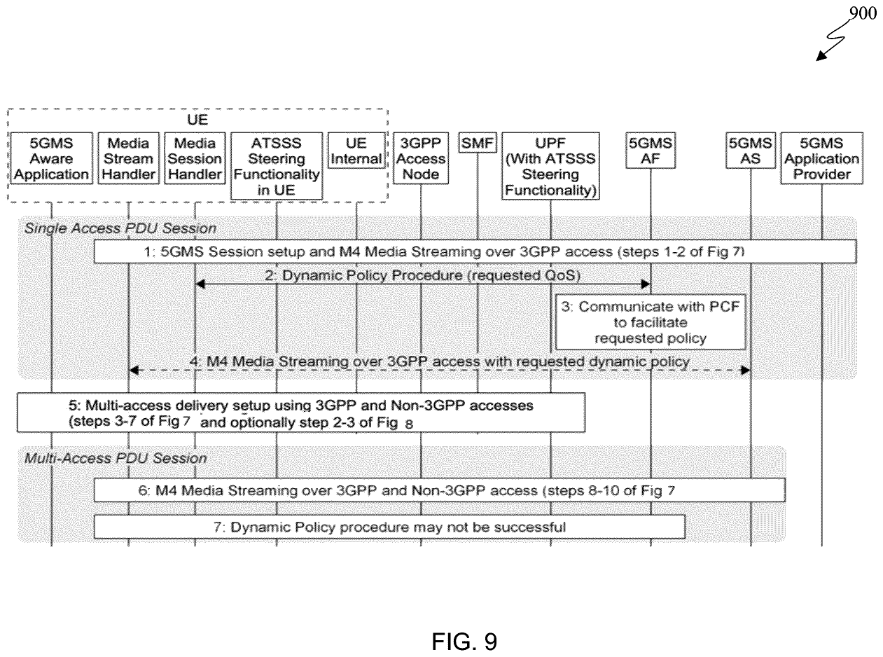

FIG. 9 illustrates an example dynamic policy procedure for a 5G media streaming session with multi-access media delivery 900 according to embodiments of the present disclosure. The embodiment of a dynamic policy procedure for a 5G media streaming session with multi-access media delivery of FIG. 9 is for illustration only. Different embodiments of a dynamic policy procedure for a 5G media streaming session with multi-access media delivery could be used without departing from the scope of this disclosure.

In the example of FIG. 9, a high-level call flow of the dynamic policy procedure for 5G media streaming before and after activation of multi-access media delivery is shown. The steps are as follows:
1. A 5G Media Streaming session over a multi-access PDU Session is set up, and M4 media flows are exchanged by the media stream handler in the UE and 5GMS AS over an access network (e.g., 3GPP access) as described herein.
2. The media session handler in the UE 5GMS client instantiates a dynamic policy in the 5GMS AF to be applied to 5G media streaming session. In some cases, a QoS specification may be provided which contains the desired QoS information.
3. The 5GMS AF interacts with the PCF on behalf of the 5GMS client (directly if the 5GMS AF is deployed in the trusted DN, or via the NEF if 5GMS AF is in the external data network) to facilitate the application of the requested dynamic policy.
4. The M4 media flows are transferred between the media stream handler and 5GMS AS over 3GPP access with the requested dynamic policy.
5. A multi-access media delivery session is set up using 3GPP access and non-3GPP access networks as described herein. The 5GMS-aware application may or may not be aware of multi-access media delivery.
6. M4 media flows are transferred over the 3GPP access and non-3GPP access, as described herein.
7. The media session handler interacts with the 5GMS AF to modify the dynamic policy so that it applies to the multi-access 5G media streaming session.
   If the M4 media flows are exchanged by the media stream handler in the UE and 5GMS AS exclusively over the 3GPP access (as a result of using the high priority rule in the received ATSSS rules reflecting either a traffic steering or traffic switching decision to the 3GPP access), the requested QoS specified in the dynamic policy instance may be successfully applied.
   If the M4 media flows are exchanged by the media stream handler in the UE and 5GMS AS exclusively over the non-3GPP access (as a result of using the high priority rule in the received ATSSS rules reflecting either a traffic steering or traffic switching decision to non-3GPP access), the requested QoS specified in the dynamic policy instance may be successfully applied if the non-3GPP access can guarantee and provide the required policy treatment.
   If the M4 media flows are exchanged by the media stream handler in the UE and 5GMS AS over both the 3GPP access and the non-3GPP access (as a result of using the high priority rule in the received ATSSS rules reflecting a traffic splitting decision to both 3GPP access and non-3GPP access), the requested QoS specified in the dynamic policy instance may be successfully applied if the non-3GPP access can guarantee and provide the required policy treatment to the traffic it carries.

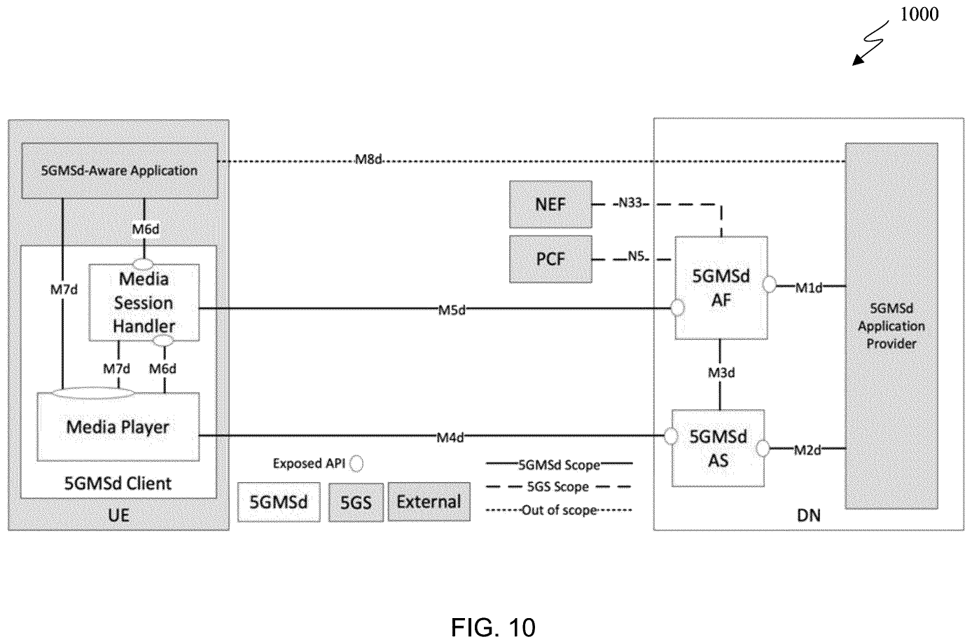

FIG. 10 illustrates an example 5GMS architecture 1000 according to embodiments of the present disclosure. The embodiment of a 5GMS architecture of FIG. 10 is for illustration only. Different embodiments of a 5GMS architecture could be used without departing from the scope of this disclosure.

In various embodiments of the present disclosure, to address the above problem of application level control with multi-access delivery, a communication system such as communications system 100 may be used to perform 5G media streaming (5GMS) based on the 5GMS architecture shown in FIG. 10, which is to be extended with the following functionality:
1. For the 5GMS-aware application to configure the following multipath delivery parameters at the 5GMSd Client:
   Enable/disable multipath media delivery.
   The number of MPQUIC paths or MPTCP subflows in the multipath delivery connection.
   Add new or remove existing MPQUIC path or MPTCP subflows to/from the multipath delivery connection.
   Which media application flows are mapped onto which MPQUIC path or MPTCP subflow.

| Status | Type | Definition |
|---|---|---|
| enableMultipathDelivery | Boolean | Configures whether to use multipath delivery using |
| | | multiple access network connection endpoints |
| pathsForMultipathDelivery | Integer | Number of paths used by the Media Stream Handler |
| | | for multipath delivery connection: |
| | | In case of MPQUIC based multipath delivery, this |
| | | parameter represents the number of MPQUIC paths |
| | | In case of MPTCP based multipath delivery, this |
| | | parameter represents the number of MPTCP subflows |
| accessNetworkEndpoints[ ] | Array | Set of access network endpoints over which the |
| | | multipath delivery connection is to be used |

2. For the 5GMS-Aware Application to be informed of the following by the 5GMSd Client:
   Connection endpoint information to each of the MPQUIC path or MPTCP subflow.
   Status information of multipath delivery connection.

| | | | |
|---|---|---|---|
| Status | Type | Parameter | Definition |

| | | |
|---|---|---|
| multipathDeliveryStatus | string | Status information of multipath |
| | | delivery connection |

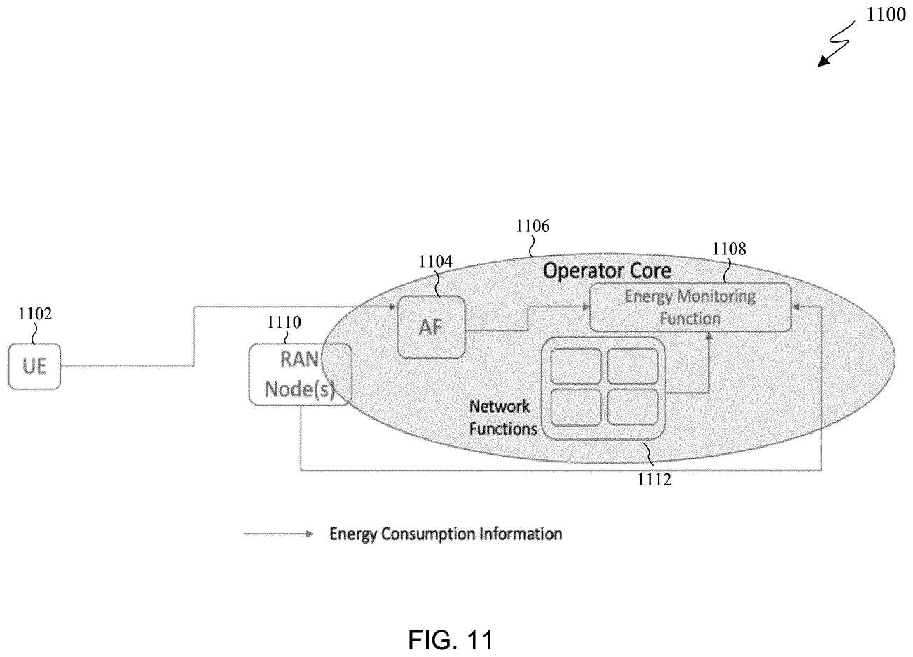

There exist applications today on the UE that indicate the power consumption of each of the apps on the UE device. Efforts are being made to decrease power consumption on different devices that participate in the service. Power consumption exposure and power savings aspects at different levels—starting from the UE to RAN nodes to core network nodes are also being worked on. Capabilities are being built where the UE reports power/energy consumption of each of its apps to some function in the network (e.g., 5G AF in the 3GPP core network, energy monitoring function), and in turn the network informs the energy consumption of the 3GPP network nodes to a designated node in the 3GPP (e.g., NWDAF in the 3GPP network, or the recently developed energy monitoring function) in the network. For example, energy consumption reporting architecture is as shown in FIG. 11.

FIG. 11 illustrates an example architecture 1100 for reporting energy consumption information according to embodiments of the present disclosure. The embodiment of reporting energy consumption information of FIG. 11 is for illustration only. Different embodiments of an architecture for reporting energy consumption information could be used without departing from the scope of this disclosure.

In the example of FIG. 11, a UE 1102 sends energy consumption information to an application function (AF) 1104 which resides in an operator core network 1106. The AF 1104, RAN nodes 1110, and network functions 1112 send energy consumption information to the energy monitoring function 1008.

Although FIG. 11 illustrates an example architecture 1100 for reporting energy consumption information, various changes may be made to FIG. 11. For example, architecture 1100 could include additional network functions, etc. according to particular needs.

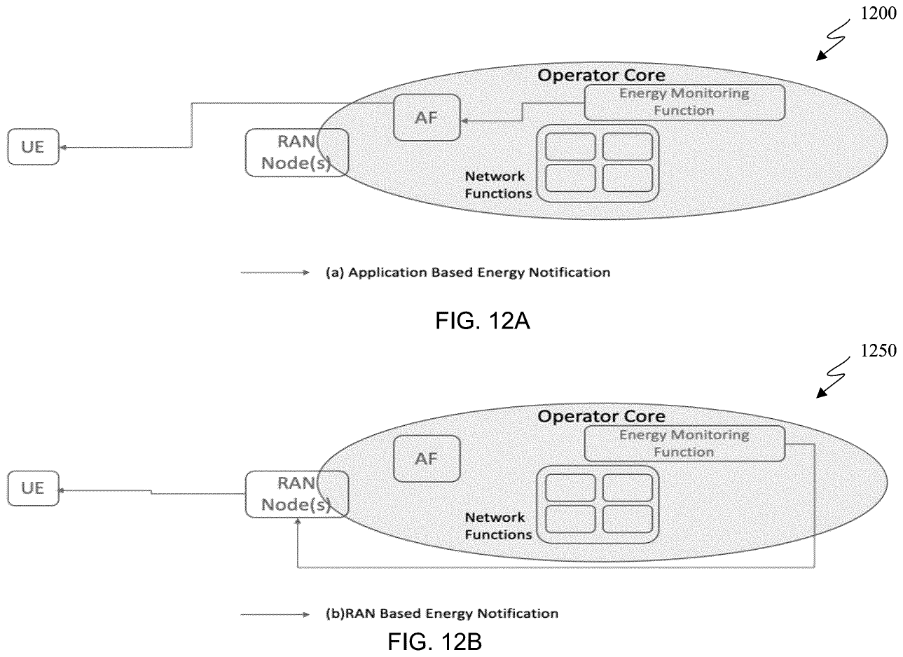

After the power/energy consumption is available at a central node in the 3GPP network (e.g., energy monitoring function 1008), energy notification information may be provided back to the UE 1102 with some feedback information as shown in FIGS. 12A and 12B.

FIGS. 12A and 12B illustrate example architectures 1200, 1250 for energy notification to a UE according to embodiments of the present disclosure. The embodiments of energy notification of FIGS. 12A and 12B are for illustration only. Different embodiments of an architecture for energy notification could be used without departing from the scope of this disclosure.

In the example of FIG. 12A, an application function (e.g., a 5G media streaming application function) may inform the UE about energy notification information. The energy monitoring function informs the application function about the energy notification information to be forwarded to the UE. The client in the UE upon receiving the energy notification information can perform actions described in the notification information to conserve power/energy.

In the example of FIG. 12B, RAN nodes take the responsibility of informing the UE about energy notification. Existing RAN based mechanisms may be used in this option. Similar to the above option, the RAN nodes get the notification information from the energy monitoring function.

Various embodiments of the present disclosure describe aspects about energy consumption and notification during multi-access delivery services with a focus on media services. For the multi-access delivery procedures described earlier herein, the network may collect the following information. Below are the steps:
1. For energy consumption reporting: Each UE that is taking part in a service reports its energy consumption to the AF and/or the energy monitoring function described earlier in the disclosure. If there are multiple UEs using the multi-access delivery, the energy monitoring function that is monitoring the energy consumption receives information from each of the UEs. Each of the UEs report the information in the following format for each of the services it reports:

| Report field | Description |
|---|---|
| Service-information | Name and description of the service that is |
| | being accessed over multiple access endpoints |
| | on the UE |
| report-start-time | Start time of energy consumption collection |
| report-end-time | End time of energy consumption collection |
| access_energyconsumption_map | Map of energy consumption over different |
| | access endpoints. Each element of this map is |
| | a <key, value> pair where: |
| | “key” is the negotiated identifier of |
| | access_network endpoint. Different access |
| | network endpoints such as 4G, LTE, 5G, |
| | NR, Wi-Fi, Satellite etc. are assigned |
| | unique identifiers and included in this key |
| | field. |
| | “value” is the amount of energy |
| | consumption on the UE because of |
| | transmitting and receiving data related to |
| | the service on the specific access network |
| | endpoint |

2. In addition to each UE, each node on each of the access paths that each of the above data/media streams flow through report the energy consumption in the same format to the application function and/or the energy monitoring function. For example, nodes such as the N3IWF (inter working function), gNB, PSA UPF, I-UPF etc. that are on the access path report the energy consumption information to carry data/media streams

From the above information received from the UE and each of the nodes in each of the access paths (all the way from the UE to the AF/AS in Data Network), the energy monitoring function computes the total energy consumption for each access path for a media service that is being used by the UE. If the media service is run on “n” number of access paths using multi-access media delivery as described earlier in the disclosure, the energy monitoring function computes total energy usage along those “n” paths.

After computing energy/power consumption along each of the access paths for a multi-access delivery service, the energy monitoring function notifies feedback information to the UE using any of the two methods (application based or RAN based energy notification) described earlier herein. The format of the energy notification information is as follows:

| Notification field | Description |
|---|---|
| Service-information | Name and description of the service that is being |
| | accessed over multiple access endpoints on the UE |
| notification-start-time | Start time of energy consumption collection for which |
| | this notification applies |
| notification-end-time | End time of energy consumption collection for which |
| | this notification applies |
| access_totalenergy_map | Map of total energy consumption over each access |
| | path. Each element of this map is a <key, value> pair |
| | where: |
| | “key” is the identifier of access_network |
| | endpoint on the UE connected to the access path for |
| | which the total energy consumption is being |
| | reported. |
| | “value” is the total amount of energy |
| | consumption over the access path |
| List of | Actions recommended for energy conservation to |
| recommendation_actions | continue accessing the media service. One or more of |
| | the following options may be recommended: |
| | Turn on multi-access media delivery: Move |
| | from a single access media delivery to a multi- |
| | access media delivery session. If this option is |
| | recommended, following additional |
| | information may be provided: |
| | List of additional access endpoints over |
| | which the UE is to request session set |
| | up for to move from single access |
| | session to a multi-access session |
| | Turn off multi-access media delivery: Move |
| | from a multi access media delivery to a single- |
| | access media delivery session. If this option is |
| | recommended, following additional |
| | information may be provided: |
| | List of access endpoints over which the |
| | UE is to terminate session to move from |
| | multi access session to a single-access |
| | session |
| | Switch-access-end-points: To move from one |
| | set of access endpoints accessing the service to |
| | a different set of access endpoints to use to |
| | access the service. If this option is |
| | recommended, following additional |
| | information may be provided: |
| | List of access endpoints to switched-to |
| | for the multi-access session |
| | Change scheduling algorithm: Change the |
| | scheduling algorithm to schedule delivery of |
| | data flows over different access endpoints |
| | Each action may be associated with a priority |
| | information for the UE to consider while adopting the |
| | action |

When the UE receives the above energy notification information from the energy monitoring function, the UE may adopt any of the recommended actions to conserve energy consumption for the media service. If the UE intends to move from a single-access media delivery session to a multi-access media delivery session, it may do so using procedures described earlier herein.

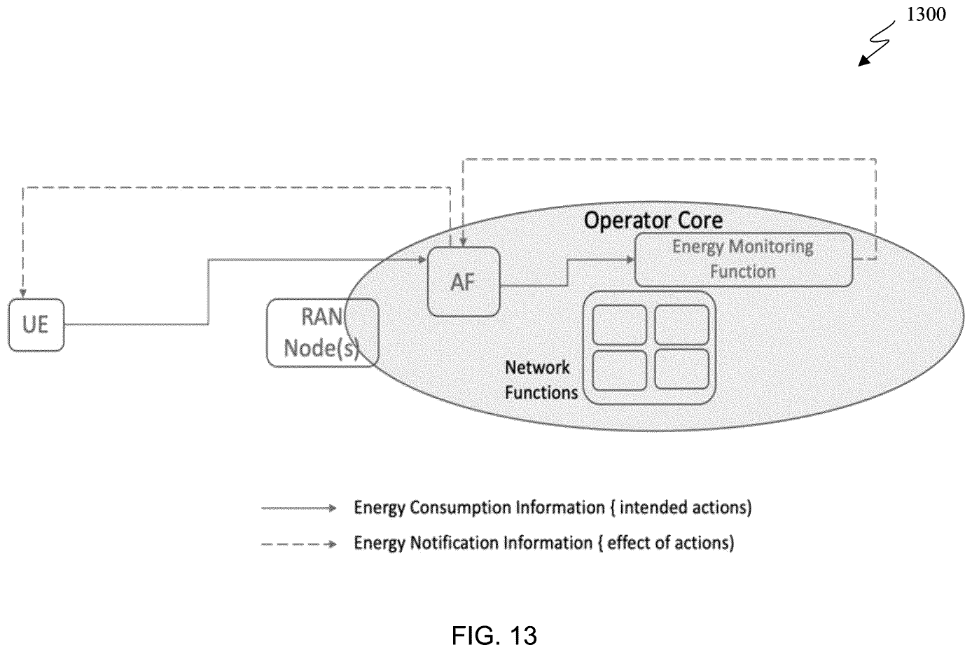

FIG. 13 illustrates an example architecture 1300 for energy notification to a UE for requested actions according to embodiments of the present disclosure. The embodiment of energy notification of FIG. 13 is for illustration only. Different embodiments of an architecture for energy notification could be used without departing from the scope of this disclosure.

In the example of FIG. 13, the UE may also send a list of intended actions along with the energy consumption information, and the network may respond back with appropriate information to help with energy conservation. In this example, in addition to reporting energy consumption information as described earlier herein, the UE also includes the following information

| Report field | Description |
|---|---|
| List of | Each element in this list an intended action |
| access_energyconsumption_actions | that the UE is willing to take to conserve |
| | energy. Possible values in this field include: |
| | Turn on multi-access media delivery: |
| | Move from a single access media |
| | delivery to a multi-access media |
| | delivery session. If this option is |
| | recommended, following additional |
| | information may be provided: |
| | List of additional access |
| | endpoints over which the UE |
| | may request session set up for |
| | to move from single access |
| | session to a multi-access |
| | session |
| | Turn off multi-access media delivery: |
| | Move from a multi access media |
| | delivery to a single-access media |
| | delivery session. If this option is |
| | recommended, following additional |
| | information may be provided: |
| | List of access endpoints over |
| | which the UE may terminate |
| | session to move from multi |
| | access session to a single- |
| | access session |
| | Switch-access-end-points: To move |
| | from one set of access endpoints |
| | accessing the service to a different |
| | set of access endpoints to use to |
| | access the service. If this option is |
| | included, following additional |
| | information may be provided: |
| | List of access endpoints to |
| | switched-to for the multi- |
| | access session |
| | Change scheduling algorithm: |
| | Change the scheduling algorithm to |
| | schedule delivery of data flows over |
| | different access endpoints |
| | The UE may include multiple actions in the |
| | proposal to the network, and may include an |
| | proposed action identifier to identify each |
| | action proposal |

When the energy monitoring function receives the above information along with energy consumption as described earlier in the disclosure, the energy monitoring function may respond back to the UE with the following notification information:

| Notification field | Description |
|---|---|
| Service-information | As described earlier herein |
| notification-start-time | As described earlier herein |
| notification-end-time | As described earlier herein |
| access_totalenergy_map | As described earlier herein |
| actions_experience_effect_map | Map of effects for each proposed action by the UE. |
| | Each element in this map is of the form <key, value> |
| | pair where: |
| | Key represents the identifier of the proposed |
| | action from the UE |
| | Value represents the service experience |
| | foreseen by the Energy Monitoring Function if |
| | the intended action is performed by the UE. |
| | Such service experience information may |
| | include foreseen QoS metrics and QoE metrics |
| | such as described in TS 26510 and TS 26512 |
| | and TS 26247. |

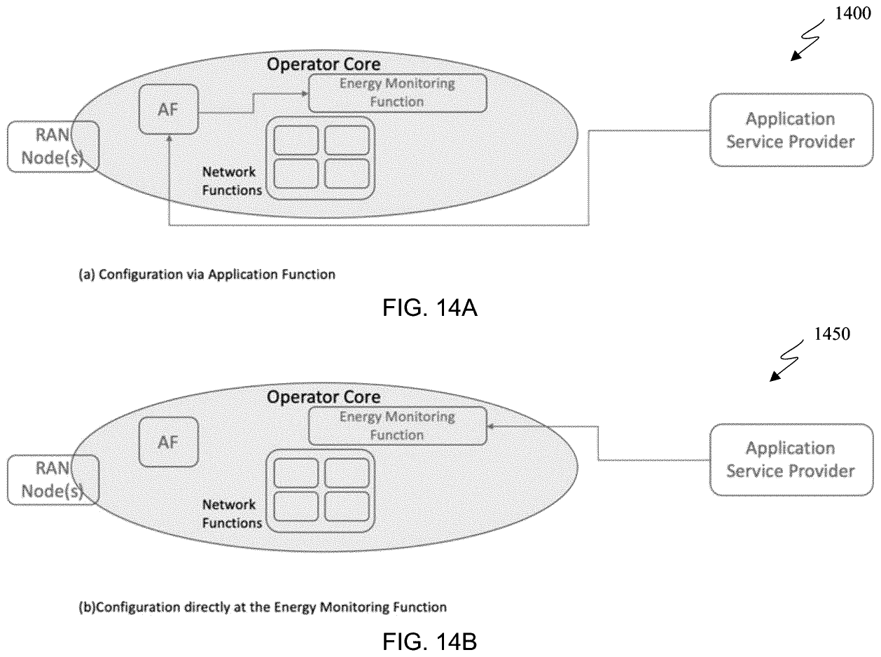

FIGS. 14A and 14B illustrate example architectures 1400, 1450 for providing recommended actions by an application service provider according to embodiments of the present disclosure. The embodiments of providing recommended actions by an application service provider of FIGS. 14A and 14B are for illustration only. Different embodiments of an architecture for providing recommended actions by an application service provider could be used without departing from the scope of this disclosure.

In the examples of FIGS. 14A and 14B, recommended actions may be provisioned by the application service provider at the energy monitoring application or via the application function. The configuration information from the application service provider is of the following format:

| Configuration Field | Description |
|---|---|
| Service-information | As described earlier herein |
| Energy_conditions_actions_map | Map of energy conditions and corresponding actions to |
| | propose to the UE. Each element of this map is of the |
| | form <key, value> pair where: |
| | Key represents an object with one or more |
| | energy conditions. Each energy condition is of |
| | the following format: |
| | Access_path: Type of access path |
| | Energy Consumption Threshold: |
| | Threshold above which the action in |
| | “value” object below is to be proposed to |
| | the UE |
| | Value represents the action to perform. The type |
| | of action to perform is similar to the actions |
| | recommended by the Energy Monitoring |
| | Function described earlier in the disclosure |

When the energy monitoring function receives the above configuration information, it knows which actions to propose to the UE based on energy consumption over an access path.

In another embodiment, the energy monitoring function may be configured to provide to the UE, not only the energy/power consumption information corresponding to the currently utilized access path, but also energy report corresponding to a plurality of alternative access configurations. For example, the EMF may notify UE of the energy consumption or an estimated energy consumption associated with one or more of: (i) single-access media delivery, (ii) enabling multi-access media delivery, (iii) disabling multi-access media delivery; (iv) switching between access end points, and (v) applying different scheduling algorithms for packet distribution access the accesses. By making available energy reports for alternative operation conditionals, the EMF enables the UE to evaluate it's prospective energy consumption under several possible delivery modes. An advantage of this approach is that the UE can autonomously determine, without requiring additional network feedback, which access configuration to employ given it's local operating context (e.g., battery state, user preference, application requirements etc). Thus, the UE may prioritize goals such as energy efficiency, throughput, latency or continuity of service by independently selecting an appropriate access strategy informed by the EMF provided energy reports.

Various embodiments of the present disclosure recognize that with the benefit of multi-access delivery to increase data throughput and bandwidth comes a cost of using multiple access networks with varied QoS capabilities. While access endpoints such as 4G LTE and 5G NR provide a reliable service, WIFI is still a best effort channel. Another problem that arises out of multi-access delivery is the problem of energy consumption. The UE and network devices may expend much higher energy to facilitate data transfer across multiple paths, as these data streams from multiple paths have to be aggregated and dis-aggregated at different locations at the UE and operator network. In addition, different application service endpoints such as application functions, application servers, CDN servers, etc. expend different amounts of energy to cater to the needs of end UE devices. It is of benefit for the UE and network elements in the operator network to allow for selection and discovery of application service endpoints with minimal energy requirements, and if there are procedures and techniques that allow for minimal energy consumption at the UE.

Accordingly, various embodiments of the present disclosure describe aspects related to enhancing existing media access procedures with energy considerations to help with energy consumption at the UE, operator network elements, and the application service provider networks, including facilitating delivery of next generation media services to UE devices with an eye towards minimizing energy consumption, and procedures for multi-CDN and multi-access delivery keeping in view the energy requirements at the UE and network. Aspects include methods and apparatuses for UE media session management and UE policy management with energy policy specification for media services, and methods and apparatuses for selection of application services for multi-CDN and multi-access delivery keeping in view the energy requirements at the UE and network.

There may be multiple levels of energy consumption at any computing device. An energy profile can be defined based on energy consumption and energy availability of the computing device. An energy profile can be specified for a specific computing device by considering the average/min/max energy consumption and energy availability of similar computing devices, and defining a range of energy consumption and availability based on those values. With that as the reference, multiple levels within that range may be specified. Each level may be associated with a scalar value. For identifying energy profile of a specific computing device, its current energy consumption and availability can be checked to see which level it corresponds to, and then assigning the corresponding scalar value as the energy profile value of the computing device. This energy profile may be standardized or negotiated between the ASP, operator network, and the UE.

Table 1 shows policy provisioning information for media streaming sessions by the ASP for users of the 5GMS system. The policy information is configured at an AF in the 5GMS system to facilitate media streaming sessions by the network operator.

TABLE 1
Policy Provisioning Information for Media Streaming Sessions

| Property | Type | Cardinality | Usage | Description |
|---|---|---|---|---|
| policyTemplateId | ResourceID | 1 . . . 1 | C: RO | Resource identifier of this Policy Template |
| | | | R: RO | assigned by the Media AF that is unique within |
| | | | U: RO | the scope of the Provisioning Session. |
| state | string enum | 1 . . . 1 | C: RO | Current state of this Policy Template (see clause |
| | | | R: RO | 5.2.7.2) exposed to the SGMS Application |
| | | | U: RO | Provider by the Media AF. |
| | | | | Only a Policy Template in the READY state may |
| | | | | be instantiated as a Dynamic Policy Instance and |
| | | | | applied to media streaming sessions. |
| stateReason | ProblemDetails | 1 . . . 1 | C: RO | Additional details about the current state of this |
| | | | R: RO | Policy Template exposed to the Media |
| | | | U: RO | Application Provider by the Media AF. |
| | | | | The instance sub-property shall be present and |
| | | | | shall indicate the URL of this Policy Template |
| | | | | resource at reference point M1 |
| | | | | The title sub-property shall be present and shall |
| | | | | indicate a human-readable representation of the |
| | | | | state property specified above, e.g., “Policy |
| | | | | Template ready for use” or “Policy Template |
| | | | | invalid”. |
| | | | | The detail sub-property shall be present and shall |
| | | | | indicate a human-readable status/error message. |
| | | | | All other properties shall be omitted.. |
| externalRefernce | string | 1 . . . 1 | C: RW | Additional identifier for this Policy Template, |
| | | | R: RW | unique within the scope of its Provisioning |
| | | | U: RW | Session, that may be cross-referenced with |
| | | | | external metadata about a media delivery session. |
| | | | | Example: •“HD_Premium” |
| applictionSession | array (object) | | C: RW | Exactly one application session context at |
| Contexts | | | R: RW | reference point M4 to which this Policy Template |
| | | | U: RW | may be applied. |
| | | | | Each object in the array shall specify at least one |
| | | | | property. If more than one property is specified, |
| | | | | instantiation of the Policy Template is restricted to |
| | | | | the conjunction of all the object's properties. |
| sliceInfo | Snssai | 0 . . . 1 | C: RW | A Network Slice on which this Policy Template |
| | | | R: RW | may be instantiated. (See clause 5.4.4.2 of TS |
| | | | U: RW | 29.571) |
| Dnn | Dnn | 0 . . . 1 | C: RW | A Data Network on which this Policy Template |
| | | | R: RW | may be instantiated. (See clause 7.3.2) |
| | | | U: RW | |
| qoSSpecifications | Array (MlQos | 0 . . . 1 | C: RW | The network Quality of Service policy envelopes |
| | Specification) | | R: RW | to be applied to the application service |
| | | | U: RW | component(s) of |
| charging | Charging | 0 . . . 1 | C: RW | The charging policy to be applied to media |
| Specification | Specification | | R: RW | delivery sessions that instantiate this Policy |
| | | | U: RW | Template is instantiated (see NOTE and clause |
| | | | | 7.3.3.7). media delivery sessions that instantiate |
| | | | | this Policy Template {see NOTE and clause |
| | | | | 7.3.3.4). |
| | | | | Each member of the array is identified by a |
| | | | | component reference that is unique in this array. |
| | | | | If present the array shall contain at least one |
| | | | | object. |
| bdtPolicyId | BdtRefernceId | 0 . . . 1 | C: RW | A reference to an existing Background Data |
| | | | R: RO | Transfer policy in the PCF (see NOTE). |
| | | | U: RW | Mutually exclusive with bdtSpecification |
| bdtSpecification | MlBDT | 0 . . . 1 | C: RIW | The Background Data Transfer policy |
| | Specification | | R: RO | specification to be associated with media delivery |
| | | | U: RW | sessions that instantiate this Policy Template (see |
| | | | | clause 8.7.3.2). |
| | | | | Mutually exclusive with bdtPolicyId property. |

NOTE:
Data type BdtRefernceId is specified in TS 29.122

In addition to the existing policy provisioning parameters described in Table 1, for energy consumption and conservation, the ASP may provide the following energy policy information:

TABLE 2
Energy Policy information

| Information Element | |
|---|---|
| Energy Policy | Description |
| Max Energy | Maximum amount of energy consumption to be allowed with |
| consumption per UE | this policy. |
| | When the UE wishes to activate this policy for its media |
| | streaming flows, the UE is required to report its energy |
| | consumption to the AF. When the AF receives the request to |
| | activate this policy, it checks the energy consumption of the |
| | media streaming app, and decides to allow this policy if the |
| | energy consumption is less than the configured maximum |
| | energy consumption. The AF then informs the UE of successful |
| | application of policy to the media streaming flows of the app. |
| | Alternately, if the energy consumption of the UE media |
| | streaming app is more than the allowed maximum energy |
| | consumption, the AF may decline facilitating the requested |
| | policy for UE application flows. |
| | If the Energy offset per UE is configured by the ASP, then the |
| | AF takes it into account while comparing the current energy |
| | consumption with the maximum energy consumption to decide. |
| Minimum Energy | Minimum amount of energy to be available at the UE for using |
| availability per UE | policy. |
| | When the UE wishes to activate this policy for its media |
| | streaming flows, the UE is required to report its energy |
| | consumption to the AF. When the AF receives the request to |
| | activate this policy, it checks the energy availability of the |
| | media streaming app, and decides to allow this policy if the |
| | energy availability is more than the configured minimum |
| | energy availability. The AF then informs the UE of successful |
| | application of policy to the media streaming flows of the app. |
| | Alternately, if the energy availability of the UE media |
| | streaming app is less than the allowed minimum energy |
| | availability, the AF may decline facilitating the requested policy |
| | for UE application flows. |
| | If the Energy offset per UE is configured by the ASP, then the |
| | AF takes it into account while comparing the current energy |
| | availability with the minimum energy availability to decide. |
| Energy offset per UE | Allowed energy offset in case the maximum amount of energy |
| | consumption is not enough for realizing this policy |
| Max Energy | Maximum amount of energy consumption to be allowed per |
| consumption per UE | slice with this policy. |
| per slice | When the UE wishes to activate this policy for its media |
| | streaming flows, the UE is required to report its energy |
| | consumption per slice to the AF. When the AF receives the |
| | request to activate this policy, it checks the energy consumption |
| | of the media streaming app, and decides to allow this policy if |
| | the energy consumption per slice is less than the configured |
| | maximum energy consumption per slice. The AF then informs |
| | the UE of successful application of policy to the media |
| | streaming flows of the app. |
| | Alternately, if the energy consumption of the UE media |
| | streaming app is more than the allowed maximum energy |
| | consumption per slice, the AF may decline facilitating the |
| | requested policy for UE application flows. |
| | If the energy offset per UE is configured by the ASP, then the |
| | AF takes it into account while comparing the current energy |
| | consumption per slice with the maximum energy consumption |
| | per slice to decide. |
| Minimum Energy | Minimum amount of energy to be available at the UE per slice |
| availability per UE per | for using policy. |
| slice | When the UE wishes to activate this policy for its media |
| | streaming flows, the UE is required to report its energy |
| | availability to the AF. When the AF receives the request to |
| | activate this policy, it checks the energy availability of the |
| | media streaming app, and decides to allow this policy if the |
| | energy availability per slice is more than the configured |
| | minimum energy availability per slice. The AF then informs the |
| | UE of successful application of policy to the media streaming |
| | flows of the app. |
| | Alternately, if the energy availability per slice of the UE media |
| | streaming app is less than the allowed minimum energy |
| | availability per slice, the AF may decline facilitating the |
| | requested policy for UE application flows. |
| | If the energy offset per UE is configured by the ASP, then the |
| | AF takes it into account while comparing the current energy |
| | availability per slice with the minimum energy availability per |
| | slice configuration to decide. |
| Energy offset per UE | Allowed energy offset per slice in case the maximum amount of |
| per slice | energy consumption per slice is not enough for realizing this |
| | policy |
| Application Session | Energy consumption levels below which the specified |
| Context energy | application session contexts are applicable. If energy |
| tolerance | consumption of the UE above this tolerance is observed, then a |
| | different set of application session contexts are possible as |
| | defined by the excess energy application session contexts |
| Excess energy | Application session contexts for high energy consuming UEs. |
| application session | ASP may configure different application session contexts for |
| contexts | multiple levels of excess energy being consumed. The ASP, |
| | may for example, configure different application session |
| | contexts (e.g. different slice and/or different DNN) for each |
| | [Energy Tolerance + ∂], [Energy Tolerance + 2∂], . . . [Energy |
| | Tolerance + n · ∂] for some n and ∂. |
| | For each level, the ASP may further configure a map of |
| | application session contexts the UE may have to migrate to use |
| | this policy. For some value k = 1 . . . n: |
| | Application session context (k) = map (key, value) where key |
| | represents the energy level and value represents the updated |
| | application session context the UE has to use at this energy |
| | level. |
| | Alternatively, the above map may be built by considering |
| | multiple levels of energy profiles of different UEs accessing the |
| | application session contexts. |
| Charging specification | Energy consumption levels below which the charging |
| energy tolerance | specification is applicable. If energy consumption of the UE |
| | above this tolerance is observed, then the charging specification |
| | above energy threshold is used instead of the regular charging |
| | specification |
| charging specification | Charging specification for higher energy consumption UEs. |
| above energy | ASP may configure charging specification for multiple levels of |
| threshold | excess energy being consumed. The ASP, may for example, |
| | configure charging specification for [Energy Tolerance + ∂], |
| | [Energy Tolerance + 2∂], . . . [Energy Tolerance + n · ∂] for some |
| | n and ∂. |
| QoS specification | Energy consumption levels below which the configured QoS |
| energy tolerance | specification is applicable. If energy consumption of the UE |
| | above this tolerance is observed, then the QoS-specification- |
| | above-energy-threshold is used instead of the regular QoS |
| | specification |
| QoS-specification- | QoS specification for higher energy consumption UEs. ASP |
| above-energy- | may configure QoS specification for multiple levels of excess |
| threshold | energy consumed. The ASP may, for example, configure QoS |
| | specification for [QoS Energy Tolerance + ∂], [QoS Energy |
| | Tolerance + 2∂], . . . [QoS Energy Tolerance + n · ∂] for some n |
| | and ∂. |
| | Either when the UE requests for QoS for its application flows, |
| | or when the network decides to apply QoS to certain UE flows, |
| | the UE reports its current energy consumption to the AF. Based |
| | on the reported energy consumption, AF checks to see which |
| | level above the energy tolerance the current energy |
| | consumption of the UE is in, and based on that level checks to |
| | see if any of the QoS specifications for that level may be |
| | provisioned for the UE application flows. |
| | Alternatively, different levels within the possible energy |
| | profiles may be used to specify different QOS specifications for |
| | each energy profile level. In this case, the UE is allowed to use |
| | only those QoS specifications that match the current Energy |
| | Profile of the UE. |
| BDT specification | Energy consumption levels below which the configured BDT |
| energy tolerance | (Background data transfer) specification is applicable. If energy |
| | consumption of the UE above this tolerance is observed, then |
| | the BDT specification above energy threshold is used instead of |
| | the regular BDT specification |
| BDT specification | BDT specification for higher energy consumption UEs. ASP |
| above energy | may configure BDT specification for multiple levels of excess |
| threshold | energy consumed. The ASP, may for example, configure BDT |
| | specification for [BDT Energy Tolerance + ∂], [BDT Energy |
| | Tolerance + 2∂], . . . [BDT Energy Tolerance + n · ∂] for some n |
| | and ∂. |
| | When the UE requests for background data transfer policy, the |
| | UE reports its current energy consumption to the AF. Based on |
| | the reported energy consumption, AF checks to see which level |
| | above the energy tolerance the current energy consumption of |
| | the UE is in, and based on that level, checks to see if any of the |
| | corresponding BDT specifications may be approved. |
| | Alternatively, different levels within the possible Energy |
| | Profiles may be used to specify different BDT specifications for |
| | each Energy Profile level. In this case, the UE is allowed to use |
| | only those BDT specifications that match the current Energy |
| | Profile of the UE. |

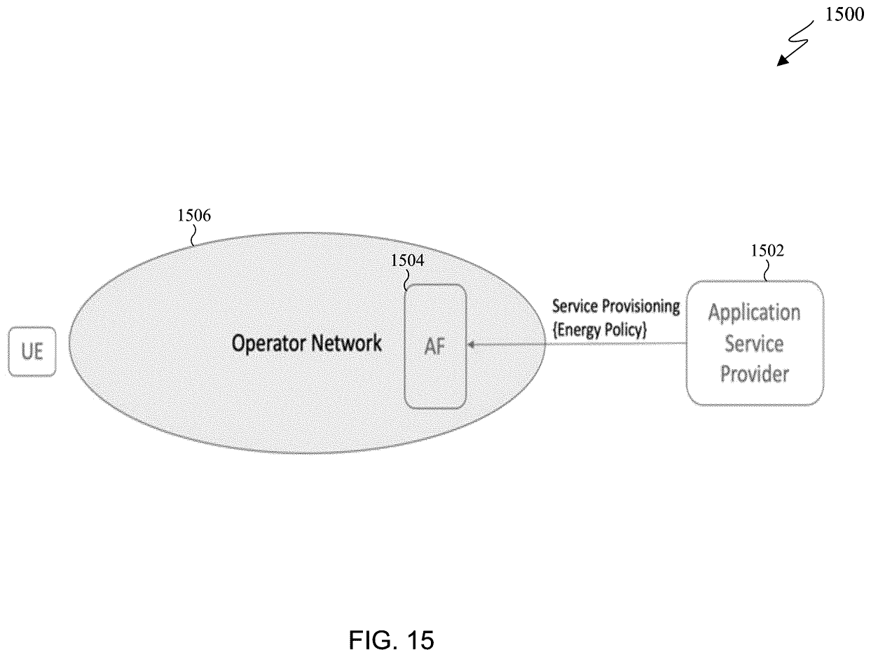

In some embodiments, a schematic for energy policy configuration by the ASP is as shown in FIG. 15.

FIG. 15 illustrates an example architecture 1500 for energy policy configuration by an ASP according to embodiments of the present disclosure. The embodiment of energy policy configuration by an ASP of FIG. 15 is for illustration only. Different embodiments of an architecture for energy policy configuration by an ASP could be used without departing from the scope of this disclosure.

In the example of FIG. 15, an application service provider 1502 sends energy policy information to an AF 1504 which resides in an operator core network 1506. Although FIG. 15 illustrates an example architecture 1500 for energy policy configuration by an ASP, various changes may be made to FIG. 15.

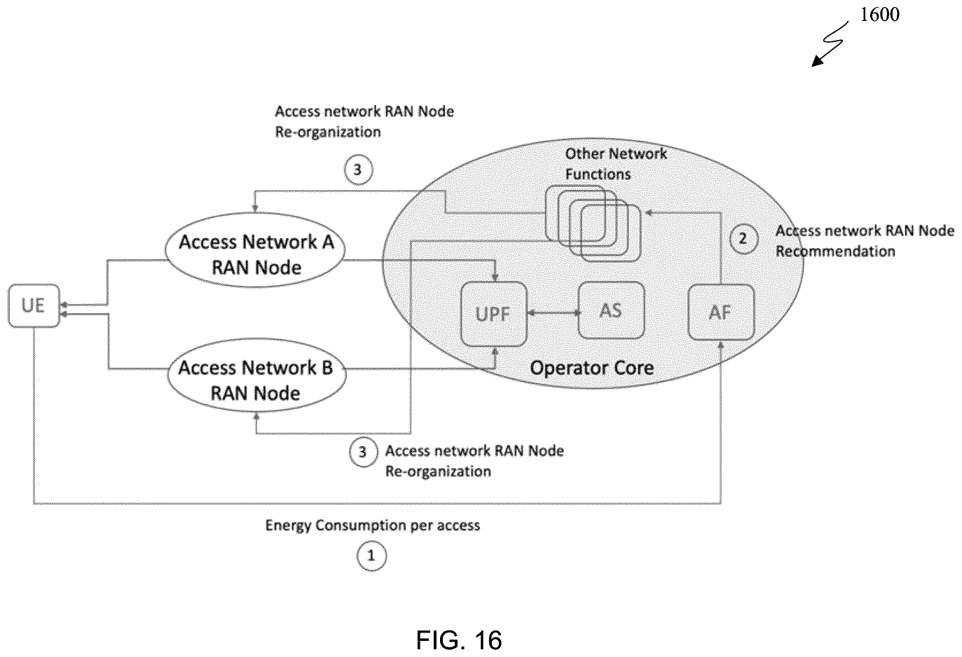

FIG. 16 illustrates an example architecture 1600 for energy management of RAN nodes with multi-access media delivery according to embodiments of the present disclosure. The embodiment of energy management of RAN nodes with multi-access media delivery of FIG. 16 is for illustration only. Different embodiments of an architecture for energy management of RAN nodes with multi-access media delivery could be used without departing from the scope of this disclosure.

In the example of FIG. 16, below are steps for managing access network RAN nodes during multi-access media delivery processes:
1. UE reports energy consumption per access to the AF. Additionally, the AF also receives energy consumption for each access network RAN node. AF has information about all UEs receiving data traffic over access network RAN node using which it can estimate energy consumption per UE at each of the access network RAN node
2. Based on energy consumption information of each UE, and energy consumption information per UE from each of the access network RAN nodes, AF infers/generates access network RAN node recommendation and informs the recommendation to other network functions in the operator network such as the PCF, AMF etc. The recommendation from the AF could be any of the options described below in Table 3.
3. Based on the received recommendation from the AF, network functions in the operator network communicate with different access network RAN nodes to perform re-organization of access network paths as described in Table 3 below.

TABLE 3
Access Network RAN node management options

| Recommendation option | Description |
|---|---|
| Turn off access network RAN | If this option is recommended by the AF, the AF also |
| node | provides information about which access network |
| | RAN node is to be powered off. When the network |
| | functions in the operator network receive this |
| | recommendation from AF, they or-organize multi- |
| | access delivery by informing the UE and network |
| | that the data streams flowing through the access |
| | network RAN node to be removed, are to be migrated |
| | to flow through another existing access network RAN |
| | node. |
| | If there would be only one access network RAN node |
| | left in multi-access media delivery session after |
| | powering off the suggested access network RAN |
| | node, then the network functions inform the UE and |
| | AF that the multi-access media delivery session is |
| | being converted to a single-access session, and all the |
| | data is to be transported through the remaining access |
| | network node. |
| Replace access network RAN | If this option is recommended by the AF, the AF |
| node | informs which access network RAN node is to be |
| | replaced (e.g., if the RAN node is consuming too |
| | much energy). |
| | Upon receiving this information from the AF, the |
| | other network functions in the operator network |
| | replace the RAN node with another similar RAN |
| | node (however a different compute instance), and re- |
| | organize data path routing of user plane traffic to be |
| | transported through the newly provisioned access |
| | network RAN node |
| Converge access network RAN | If this option is recommended by the AF, the AF |
| nodes | provides the list of all access network RAN nodes to |
| | be converged. |
| | When this recommendation is received by other |
| | network functions in the operator network, they take |
| | steps to converge the RAN nodes of all access |
| | network nodes onto the same hardware/orchestration |
| | platform. The AF may provide information about |
| | where the converged platform is to reside. Optionally, |
| | the AF may indicate which access network RAN |
| | node is to be considered primary and processing of |
| | all other RAN nodes be converged with this primary |
| | RAN node. |
| | The UE is to be informed about updated network |
| | destination parameters on one or more access |
| | network endpoints. When the UE receives this |
| | information, it starts sending the data streams to the |
| | newly provisioned converged platform. |
| Pause access network RAN nodes | If this option is recommended by the AF, the AF may |
| | provide the one or more specific access network |
| | RAN nodes to be paused. Additionally, the AF may |
| | also provide information about how long each of the |
| | access network RAN nodes to be paused. |
| | When the other network functions receive this |
| | recommendation from the AF, they take steps to |
| | pause the suggested access network RAN nodes. In |
| | this case, the network functions may inform the UE |
| | that one or more access RAN nodes are paused, |
| | which causes the UE to re-organize the routing of |
| | user plane paths that are flowing through access |
| | network RAN nodes that are paused. |
| | Optionally, the UE application and the application on |
| | the UPF may figure that one or more paths are |
| | unavailable (based on pausing of access network |
| | RAN nodes by other network functions), and |
| | therefore may re-organize the routing of user plane |
| | paths that are flowing through those access network |
| | RAN nodes that are unavailable. |

In a multi-CDN environment, UE media streaming application is made aware of multiple CDN entry points from which content may be downloaded or streamed. One example of making the UE application aware of multiple CDN access nodes is using <BaseURL> inside a DASH MPD (media presentation document). This document is sent by the application service provider to the application server, which forwards the MPD to the UE application.

To facilitate selection of appropriate CDN node by the UE application, the DASH MPD may include the below information alongside each of the BaseURL property to indicate additional information about each of the CDN access nodes:

| MPD Base URL Properties | Description |
|---|---|
| Average/min/max energy consumption per | Average/min/max expected energy |
| UE | consumption by the UE to access media |
| | content from this CDN access node |
| Average/min/max energy consumption per | Average/min/max expected energy |
| media segment | consumption per media segment if this CDN |
| | access node is used for retrieving of content |
| Average/min/max energy consumption per | Average/min/max expected energy |
| elementary stream | consumption per elementary if this CDN |
| | access node is used for retrieving of content |
| Average/min/max outage time | Average/min/max of outage time in a given |
| | time frame for this CDN access node |
| Recommended Energy profile | Indicates which UEs are recommended to |
| | access this CDN node based on the UE's |
| | energy profile. |
| | So, when the UE needs to access a BaseURL |
| | (CDN node), it can check to see which |
| | BaseURLs are recommended based on its |
| | energy profile, and then decides to retrieve |
| | content from those URLs. |
| Average/min/max number of requests | Average/min/max number of requests per unit |
| | time (e.g., a day) that this CDN node receives |
| | from different UEs. |

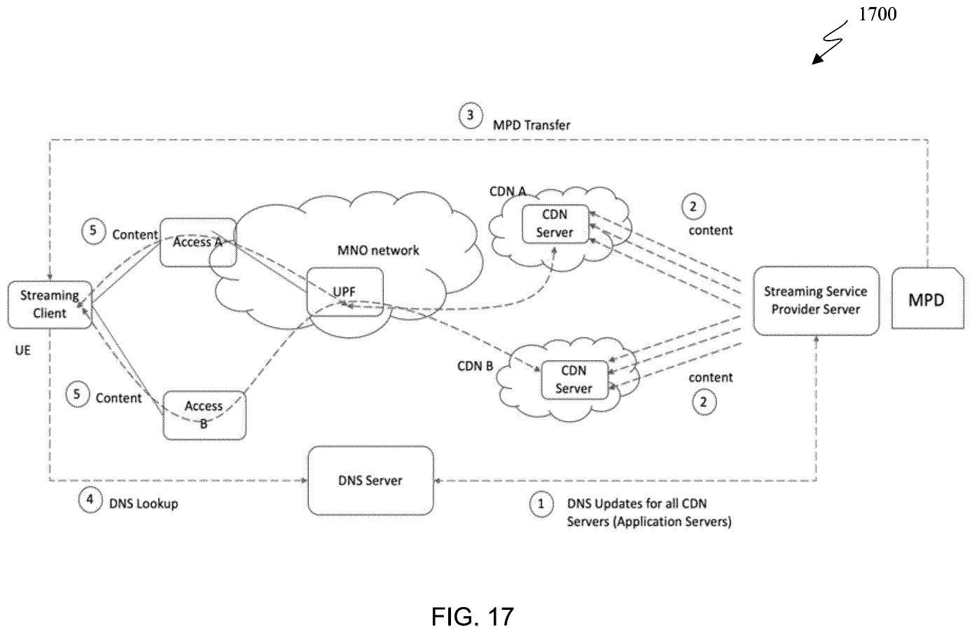

Application servers may be configured or specified with energy profiles of UEs that can access content from them. In various embodiments of the present disclosure, a procedure is described for including the energy profile information of UEs that can access an application server in DNS TXT records. The procedure is described in FIG. 17.

FIG. 17 illustrates an example architecture 1700 for a DNS based procedure for application server lookup according to embodiments of the present disclosure. The embodiment of a DNS based procedure for application server lookup of FIG. 17 is for illustration only. Different embodiments of an architecture for a DNS based procedure for application server lookup could be used without departing from the scope of this disclosure.

The steps for the above procedure are described below:
(1) The external streaming service provider (application service provider) configures DNS entries of different CDN services in the operator DNS service. The CDN service endpoints are configured with energy related information as described later in this embodiment. For this configuration, the ASP may negotiate with the operator, and take assistance from network functions inside the operator network.
(2) The application service provider or streaming service provider ingests content into different CDN services/servers (application servers).
(3) The UE retrieves the media presentation document describing service locations of different CDN services from the ASP
(4) The UE performs DNS lookup with the operator DNS server to check the energy requirements to access each CDN server to decide which application server or CDN service to access
(5) The UE accesses the content from those application servers keeping in mind the energy requirements

The DNS entries in the operator network are populated for each CDN service. DNS TXT records for the CDN services provide information about energy considerations to access the specific CDN service.

For each CDN server/service, the DNS TXT records of following form are configured:

| CDN-service-A.com | record type | Value | TTL |
|---|---|---|---|
| @ | TXT | <Details described below> | 32600 |

The “value” field of DNS TXT records for each CDN Service may be enhanced with the following information:

| Information Element | Description |
|---|---|
| Average-UE-Energy-Profile | UEs whose average energy profile are recommended to use |
| | this CDN service application server to access content |
| Min-UE-Energy-Profile | UEs below this minimum energy profile are not |
| | recommended to use this CDN service application server to |
| | access content |
| Average/min/max energy | Average/min/max expected energy consumption by the UE to |
| consumption per UE | access media content from this CDN service application |
| | server |
| Average/min/max energy | Average/min/max expected energy consumption per media |
| consumption per media segment | segment if this CDN service application server is used for |
| | retrieving of content |
| Average/min/max energy | Average/min/max expected energy consumption per |
| consumption per elementary | elementary if this CDN service application server is used for |
| stream | retrieving of content |
| Average/min/max outage time | Average/min/max of outage time in a given time frame for |
| | this CDN service application server |
| Average/min/max number of | Average/min/max number of requests per unit time (e.g., a |
| requests | day) that this CDN node receives from different UEs. |

With the above DNS TXT information available for each CDN service application server, the UE can check each application server to see which server provides the optimal energy performance given UEs current energy profile and consumption needs. The UE may then proceed to request content from the chosen application server.

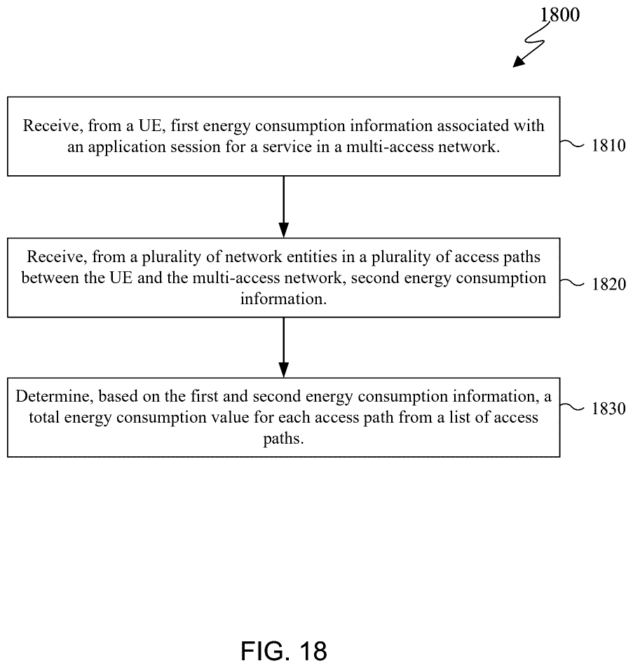

FIG. 18 illustrates an example method 1800 for monitoring energy consumption according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. In some examples, the method 1800 may be performed by the energy monitoring function 1008 and/or the server 200 collectively referred to as the device. Other embodiments of the method 1800 for edge computing with multi-access delivery could be used without departing from the scope of this disclosure.

The method 1800 begins with the device receiving, from a UE, first energy consumption information associated with an application session for a service in a multi-access network (1810). The device then receives, from a plurality of network entities in a plurality of access paths between the UE and the multi-access network, second energy consumption information (1820). For example, in 1810 and 1820, the first and second energy consumption information includes a service identifier corresponding to the service, a start time, an end time, and an access energy consumption map indicating a list of access paths, including access end points or network functions in each access path from the list of access paths, used to access the service between the start and end times and measured energy consumption attributed to the access end points or the network functions corresponding to the access paths from the list of access paths.

The device then determines, based on the first and second energy consumption information, a total energy consumption value for each of the access paths from the list of access paths (1830).

In one or more embodiments, the device transmits, to the UE, a notification including the total energy consumption value for each of the access paths from the list of access paths and a list of recommended actions related to conserving energy. The list includes at least one of turning on a multi-access delivery, turning off the multi-access delivery, switching to alternative access endpoints, and changing a scheduling algorithm to schedule delivery of data flows over different access paths.

In one or more embodiments, the list further includes at least one of a first list of access end points over which the UE is to request session set-up in order to transition from single-access delivery to the multi-access delivery, a second list of access end points over which the UE is to request session modification in order to transition from the multi-access delivery to the single-access delivery, and a third list of access end points for the UE to switch to, while maintaining the single-access delivery or multi-access delivery.

In one or more embodiments, the device receives, from the UE, one or more proposals related to energy conservation and transmits, to the UE, feedback for each of the one or more proposals. The feedback indicates predicted effects on service metrics including QoS and QoE. The one or more proposals include at least one of turning on or off a multi-access delivery, switching to alternative access endpoints, and changing a scheduling algorithm to schedule delivery of data flows over different access paths,

In one or more embodiments, the device receives, from an application service provider, configuration information. The configuration information includes a plurality of energy conditions, each indicating an access path and energy consumption threshold corresponding to the access path, and one or more actions corresponding to each of the energy conditions, receive, from the UE, an energy status. The device determines, based on the energy status, at least one action from the one or more actions and transmits, to the UE, the at least one action.

In one or more embodiments, the device receives, from an application service provider, energy policy information. The energy policy information includes at least one of a maximum energy consumption value per UE or per UE per slice for applying a policy, a minimum energy availability value per UE or per UE per slice for applying the policy, an energy offset value per UE or per UE per slice that modifies or adjusts a threshold for determination of the policy, an application session context energy tolerance specifying energy consumption levels below which corresponding session contexts are applicable, an excess energy application session context for application session migration when observed UE energy consumption exceeds a defined threshold, a charging specification energy tolerance specifying charging parameters based on energy consumption levels, a QoS specification energy tolerance for assigning QoS parameters based on reported UE energy consumption, and a BDT specification energy tolerance for configuration and management of data transfer operation based on energy consumption levels.

In one or more embodiments, the device transmits recommendations relating to energy conservation of RAN nodes in each of the access paths. The recommendations include at least one of turning off or pausing one or more of the RAN nodes for a defined time interval, converging one or more of the RAN nodes into a common hardware, and replacing one or more of the RAN nodes.

In one or more embodiments, the device transmits a MPD file including information about a number of CDN access nodes, the MPD file includes, for each CDN access node, metadata specifying average, minimum, and maximum energy consumption per UE or per media segment, and recommended energy profile. The metadata enables the UE to select the CDN access node for media delivery based on at least in part on energy status of the UE.

In one or more embodiments, the device transmits, to the UE, a notification including total energy consumption value for a currently utilized access configuration and total energy consumption value for a set of alternative access configurations. The set of alternative access configurations include at least one of single-access media delivery, multi-access media delivery, switching between the access end points or the network functions, and applying different scheduling algorithms for distributing a media traffic corresponding to the service.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for monitoring energy consumption, the method comprising:
receiving, from a user equipment (UE), first energy consumption information associated with an application session for a service in a multi-access network;
receiving, from a plurality of network entities in a plurality of access paths between the UE and the multi-access network, second energy consumption information, wherein the first and second energy consumption information includes:
a service identifier corresponding to the service,
a start time indicating a time at which measurement of energy consumption began,
an end time indicating a time at which measurement of energy consumption ended, and
an access energy consumption map indicating (i) a list of access paths, including access end points or network functions in each access path from the list of access paths, used to access the service between the start and end times and (ii) measured energy consumption attributed to the access end points or the network functions corresponding to the access paths from the list of access paths; and
determining, based on the first and second energy consumption information, a total energy consumption value for each of the access paths from the list of access paths.

2. The method of claim 1, further comprising:
transmitting, to the UE, a notification including:
the total energy consumption value for each of the access paths from the list of access paths, and
a list of recommended actions related to conserving energy, the list including at least one of:
turning on a multi-access delivery,
turning off the multi-access delivery,
switching to alternative access endpoints, and
changing a scheduling algorithm to schedule delivery of data flows over different access paths.

3. The method of claim 2, wherein the list further includes at least one of:
a first list of access end points over which the UE is to request session set-up in order to transition from single-access delivery to the multi-access delivery,
a second list of access end points over which the UE is to request session modification in order to transition from the multi-access delivery to the single-access delivery, and
a third list of access end points for the UE to switch to, while maintaining the single-access delivery or multi-access delivery.

4. The method of claim 1, further comprising:
receiving, from the UE, one or more proposals related to energy conservation, wherein the one or more proposals include at least one of:
turning on or off a multi-access delivery,
switching to alternative access endpoints, and
changing a scheduling algorithm to schedule delivery of data flows over different access paths, and
transmitting, to the UE, feedback for each of the one or more proposals, wherein the feedback indicates predicted effects on service metrics including quality of service (QOS) and quality of experience (QoE).

5. The method of claim 1, further comprising:
receiving, from an application service provider, configuration information, wherein the configuration information includes:
a plurality of energy conditions, each indicating an access path and energy consumption threshold corresponding to the access path, and
one or more actions corresponding to each of the energy conditions, receiving, from the UE, an energy status;
determining, based on the energy status, at least one action from the one or more actions; and
transmitting, to the UE, the at least one action.

6. The method of claim 1, further comprising:
receiving, from an application service provider, energy policy information,
wherein the energy policy information includes at least one of:
a maximum energy consumption value per UE or per UE per slice for applying a policy,
a minimum energy availability value per UE or per UE per slice for applying the policy,
an energy offset value per UE or per UE per slice that modifies or adjusts a threshold for determination of the policy,
an application session context energy tolerance specifying energy consumption levels below which corresponding session contexts are applicable,
an excess energy application session context for application session migration when observed UE energy consumption exceeds a defined threshold,
a charging specification energy tolerance specifying charging parameters based on energy consumption levels,
a quality of service (QOS) specification energy tolerance for assigning QoS parameters based on reported UE energy consumption, and
a background data transfer (BDT) specification energy tolerance for configuration and management of data transfer operation based on energy consumption levels.

7. The method of claim 1, further comprising:
transmitting recommendations relating to energy conservation of radio access network (RAN) nodes in each of the access paths,
wherein the recommendations include at least one of:
turning off or pausing one or more of the RAN nodes for a defined time interval,
converging one or more of the RAN nodes into a common hardware, and
replacing one or more of the RAN nodes.

8. The method of claim 1, further comprising:
transmitting a media presentation description (MPD) file including information about a number of content delivery network (CDN) access nodes, wherein:
the MPD file includes, for each CDN access node, metadata specifying:
average, minimum, and maximum energy consumption per UE or per media segment, and
recommended energy profile, and
the metadata enables the UE to select the CDN access node for media delivery based on at least in part on energy status of the UE.

9. The method of claim 1, further comprising:
transmitting, to the UE, a notification including (i) total energy consumption value for a currently utilized access configuration, and (ii) total energy consumption value for a set of alternative access configurations,
wherein the set of alternative access configurations include at least one of:
single-access media delivery,
multi-access media delivery,
switching between the access end points or the network functions, and
applying different scheduling algorithms for distributing a media traffic corresponding to the service.

10. An apparatus for monitoring energy consumption, the apparatus comprising:
a communication interface configured to:
receive, from a user equipment (UE), first energy consumption information associated with an application session for a service in a multi-access network; and
receive, from a plurality of network entities in a plurality of access paths between the UE and the multi-access network, second energy consumption information, wherein the first and second energy consumption information includes:
a service identifier corresponding to the service,
a start time indicating a time at which measurement of energy consumption began,
an end time indicating a time at which measurement of energy consumption ended, and
an access energy consumption map indicating (i) a list of access paths, including access end points or network functions in each access path from the list of access paths, used to access the service between the start and end times and (ii) measured energy consumption attributed to the access end points or the network functions corresponding to the access paths from the list of access paths; and
a processor operably coupled with the communication interface, the processor configured to determine, based on the first and second energy consumption information, a total energy consumption value for each of the access paths from the list of access paths.

11. The apparatus of claim 10, wherein:
the communication interface is further configured to transmit, to the UE, a notification including:
the total energy consumption value for each of the access paths from the list of access paths, and
a list of recommended actions related to conserving energy, the list including at least one of:
turning on a multi-access delivery,
turning off the multi-access delivery,
switching to alternative access endpoints, and
changing a scheduling algorithm to schedule delivery of data flows over different access paths.

12. The apparatus of claim 11, wherein the list further includes at least one of:
a first list of access end points over which the UE is to request session set-up in order to transition from single-access delivery to the multi-access delivery,
a second list of access end points over which the UE is to request session modification in order to transition from the multi-access delivery to the single-access delivery, and
a third list of access end points for the UE to switch to, while maintaining the single-access delivery or multi-access delivery.

13. The apparatus of claim 10, wherein the communication interface is further configured to:
receive, from the UE, one or more proposals related to energy conservation, wherein the one or more proposals include at least one of:
turning on or off a multi-access delivery,
switching to alternative access endpoints, and
changing a scheduling algorithm to schedule delivery of data flows over different access paths, and
transmit, to the UE, feedback for each of the one or more proposals, wherein the feedback indicates predicted effects on service metrics including quality of service (QOS) and quality of experience (QoE).

14. The apparatus of claim 10, wherein:
the communication interface is further configured to:
receive, from an application service provider, configuration information, wherein the configuration information includes:
a plurality of energy conditions, each indicating an access path and energy consumption threshold corresponding to the access path, and
one or more actions corresponding to each of the energy conditions,
receive, from the UE, an energy status;
the processor is further configured to determine, based on the energy status, at least one action from the one or more actions; and
the communication interface is further configured to transmit, to the UE, the at least one action.

15. The apparatus of claim 10, wherein:
the communication interface is further configured to receive, from an application service provider, energy policy information, and
the energy policy information includes at least one of:
a maximum energy consumption value per UE or per UE per slice for applying a policy,
a minimum energy availability value per UE or per UE per slice for applying the policy,
an energy offset value per UE or per UE per slice that modifies or adjusts a threshold for determination of the policy,
an application session context energy tolerance specifying energy consumption levels below which corresponding session contexts are applicable,
an excess energy application session context for application session migration when observed UE energy consumption exceeds a defined threshold,
a charging specification energy tolerance specifying charging parameters based on energy consumption levels,
a quality of service (QOS) specification energy tolerance for assigning Qos parameters based on reported UE energy consumption, and
a background data transfer (BDT) specification energy tolerance for configuration and management of data transfer operation based on energy consumption levels.

16. The apparatus of claim 10, wherein:
the communication interface is further configured to transmit recommendations relating to energy conservation of radio access network (RAN) nodes in each of the access paths, and
the recommendations include at least one of:
turning off or pausing one or more of the RAN nodes for a defined time interval,
converging one or more of the RAN nodes into a common hardware, and
replacing one or more of the RAN nodes.

17. The apparatus of claim 10, wherein:
the communication interface is further configured to transmit a media presentation description (MPD) file including information about a number of content delivery network (CDN) access nodes,
the MPD file includes, for each CDN access node, metadata specifying:
average, minimum, and maximum energy consumption per UE or per media segment, and
recommended energy profile, and
the metadata enables the UE to select the CDN access node for media delivery based on at least in part on energy status of the UE.

18. The apparatus of claim 10, wherein:
the communication interface is further configured to transmit, to the UE, a notification including (i) total energy consumption value for a currently utilized access configuration and (ii) total energy consumption value for a set of alternative access configurations, and
the set of alternative access configurations include at least one of:
single-access media delivery,
multi-access media delivery,
switching between the access end points or the network functions, and
applying different scheduling algorithms for distributing a media traffic corresponding to the service.

19. A non-transitory, computer readable medium comprising program code that, when executed by a processor of an apparatus, causes the apparatus to:
receive, from a user equipment (UE), first energy consumption information associated with an application session for a service in a multi-access network;
receive, from a plurality of network entities in a plurality of access paths between the UE and the multi-access network, second energy consumption information, wherein the first and second energy consumption information includes:
a service identifier corresponding to the service,
a start time indicating a time at which measurement of energy consumption began,
an end time indicating a time at which measurement of energy consumption ended, and
an access energy consumption map indicating (i) a list of access paths, including access end points or network functions in each access path from the list of access paths, used to access the service between the start and end times and (ii) measured energy consumption attributed to the access end points or the network functions corresponding to the access paths from the list of access paths; and
determine, based on the first and second energy consumption information, a total energy consumption value for each of the access paths from the list of access paths.

20. The computer readable medium of claim 19, further comprising program code that, when executed by the processor of the apparatus, causes the apparatus to:
transmit, to the UE, a notification including:
the total energy consumption value for each of the access paths from the list of access paths, and
a list of recommended actions related to conserving energy, the list including at least one of:
turning on a multi-access delivery,
turning off the multi-access delivery,
switching to alternative access endpoints, and
changing a scheduling algorithm to schedule delivery of data flows over different access paths.
